(19) United States
(12) Patent Application Publication
(10) Pub. No.: US 2004/0203877 A1
(43) Pub. Date: Oct. 14, 2004

(54) Two-way ranging techniques

(76) Inventor: Stuart A. Golden, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/274,417

(22) Filed: Oct. 17, 2002

(51) Int. Cl. H04B 17/00; H04Q 7/20; H04B 1/38

(52) U.S. Cl. 455/456.1; 455/575.1; 455/67.11

(57) ABSTRACT

A first communication unit transmits a first signal to a second communication device and concurrently processes the first signal in its receiver. A second communication unit transmits a second signal to the first communication device and concurrently processes the second signal in its receiver. Both communication units use the first and second signals to calculate time difference values that in turn may be used to calculate the distance between the first and second communication units.

In a communication system, multiple base stations provide wireless communication services to mobile users within the system. Base stations typically service multiple mobile users within a coverage region or cell associated with the base station. To allow multiple users to share a base station, a variety of multiple access schemes have been employed. The multiple access schemes allow each user in the communication system to transmit and receive data-bearing signals and, in general, communicate with other users located within the cell or located in other cells. The mobile communication device extracts data from the composite signal received from one or more base stations and provides processing to reduce multi-path propagation differences that cause multi-user interference and fading and disrupt communication.

Within such a communication system, a mobile user may be accurately located or a vehicle precisely pinpointed using a Global Positioning System (GPS) to measure and determine distances. The GPS system consists of 24 satellites, which broadcast their positions and times accurately using atomic clocks as very accurate timekeepers. A communications device having a GPS receiver may take the timing information and use it to calculate its own position on the earth, comparing its time with the time broadcast by at least 3 satellites whose positions are known. Although the GPS system uses the time differences to accurately pinpoint the location of the mobile user, the GPS system depends on expensive atomic clocks in the GPS transmitters to generate the precision measurements.

Accordingly, it is desired to provide techniques and methods as an alternative to the GPS system that provide an accurate location of a mobile device within a communication system. And unlike GPS receivers that only operate up to a fixed sensitivity level which is exceeded by the path loss due to the signal propagating through interior and exterior walls and surfaces, it is further desired to provide techniques and methods that work in most indoor environments.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a transceiver portion and processor of a device in communication with another device in a communication system in accordance with the present invention;

FIGS. 2-5 illustrate signals being transmitted and received by two communication devices in a communication system; and

FIG. 6 illustrates a communication system in which the principles of the present invention may be practiced.

Where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

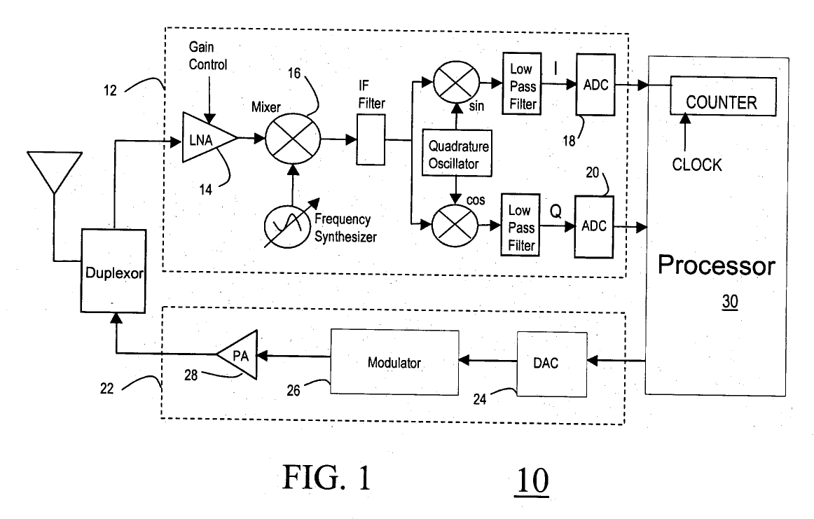

FIG. 1 illustrates a device 10 in which the principles of the present invention may be practiced, the device including a transceiver having a receiver 12 and a transmitter 22 that are connected to a processor 30. Device 10 may transmit and receive signals and process signal information that may be used to determine the location of devices in the communication network. It should be noted that embodiments of the present invention may be used in a variety of applications, with the claimed subject matter incorporated into microcontrollers, general-purpose microprocessors, Digital Signal Processors (DSPs), Reduced Instruction-Set Computing (RISC), Complex Instruction-Set Computing (CISC), baseband and application processors, among other electronic components. The present invention may also be incorporated into devices such as access points, mobile units, base stations, smart phones, communicators and Personal Digital Assistants (PDAs), platform OS based devices, cameras, safety devices, automotive infotainment units and other products. However, it should be understood that the scope of the present invention is not limited to these examples.

In one embodiment device 10 may operate in a wireless Local Area Network (LAN) using one of the Institute of Electrical and Electronics Engineers (IEEE 802.11) protocols. For instance, 802.11a is a Physical Layer standard that specifies operating in the 5 GHz band using Orthogonal Frequency Division Multiplexing (OFDM) and the 802.11g standard specifies operating in the 2.4GHz frequency band. Device 10 may be designed to operate using either the 802.11a, 802.11b or 802.11g protocol, or in alternative embodiments, in a Code Division Multiple Access (CDMA) cellular network using protocols such as IS-95, CDMA 2000, UMTS-WCDMA, or in a Global System for Mobile Communications (GSM) using Time Division Multiple Access (TDMA). In these CDMA, GSM and TDMA networks device 10 may include hardware to provide a frequency translation to account for the device transmitting and receiving in different frequency bands. This approach is applicable to all wireless communication devices that have both a transmitter and receiver.

The block diagram in FIG. 1 for device 10 shows modulated Radio Frequency (RF) signals being received at an antenna. Receiver 12 may recover the information contained in the RF signals. A Low Noise Amplifier (LNA) 14 receives the incoming modulated RF signals and controls the amplification while maintaining a good signal-to-noise ratio. A mixer 16 receives the amplified RF signals and down converts the high frequency modulated signals to a lower frequency range. Thus, the modulated RF signals may be “mixed” with a Local Oscillator (LO) signal to translate the carrier frequency of the modulated signal from the RF range to the Intermediate Frequency (IF) range.

The down converted signals may then be filtered and separated into an “inphase” portion and a “quadrature” portion. The inphase analog signals (I) may be converted to digital values by an Analog-to-Digital Converter (ADC) 18, while the quadrature analog signals (Q) may be converted to digital values by ADC 20. Processor 30 may process these digital values of the baseband signals. It should be noted that in an alternative embodiment of receiver 12, the modulated RF signals may be directly down converted without the use of IF mixers and that the scope of the claims is intended to cover either embodiment of the receiver.

A Digital-to-Analog Converter (DAC) 24 in transmitter 22 may convert a digital value generated by processor 30 to an analog output signal that is proportional to the input digital value. The analog signal may then be modulated in modulator 26 before upconverting to RF frequencies. A power amplifier 28 may control the output power of the analog signal transmitted from the antenna. The present invention should not be limited by the specific method of conversion employed in DAC 24, the resolution of the DAC as related to the number of bits or the voltage range or linearity of the DAC.

In accordance with embodiments of the present invention, device 10 determines when the transmission signal is sent and may use a counter that begins counting when the transmission is sent. The sampling interval of the counter should be smaller than the desired accuracy of the range measurement. By way of example, if the desired accuracy for the range measurement is one meter or better, then the counter should be clocked at a frequency of 300 MHz or greater. The counter stops counting when a signal is received from the other communication unit.

In an alternative embodiment that does not use a high speed counter, receiver 12 receives signals being transmitted by transmitter 22 and signal processing techniques may be used to determine the exact time that the signal was transmitted. Thus, in contrast to some prior art transceivers, receiver 12 is active during the time that transmitter 22 is providing a signal to the antenna. The Gain Control signal to LNA 14 may be used to attenuate the signal being conducted by receiver 12 as provided from the output of transmitter 22. Thus, for clarity and by way of example, the signal provided by processor 30 and passed through the signal path that includes DAC 24, modulator 26 and PA 28 is transmitted from the antenna, but also received in receiver 12 and passed through the signal path that includes LNA 14, mixer 16 and ADCs 18 and 20. Put another way, the digital signal generated by processor 30 is converted to an analog signal (DAC 24), then modulated (Modulator 26), frequency translated and amplified (PA 28) for transmitting from the antenna, and then frequency down-converted (mixer 16), filtered, and converted to inphase and quadrature digital signals (ADC 18 and 20) for processing by processor 30. A time delay is associated with this signal path from processor 30 through transmitter 22 to the antenna and through receiver 12 back to processor 30.

It should be pointed out that a dedicated path from the transmitter to the receiver may allow the transceiver to receive the signal that it is also transmitting. However, in many cases this dedicated path may not be necessary. The duplexor in the signal path acts like an attenuator between the transmitter port and the receiver port in the transmit mode. In many applications this attenuation is sufficient but more or less attenuation may be added for a particular system. For example, if additional attenuation is desired then a switch attenuator may be included in the receive band. The attenuator would be active during times when it is desired to estimate the time at which transmitted signal is sent.

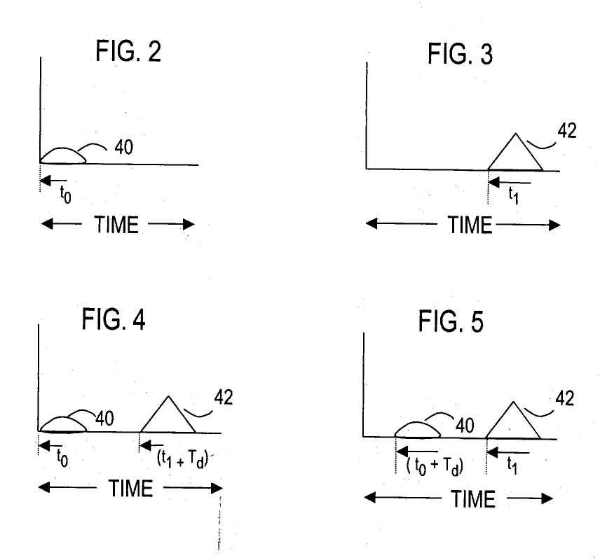

FIGS. 2-5 illustrate signals communicated between two devices such as two mobile devices, two base stations, one mobile device and one base station, or in general, any two communication units having a transmitter and a receiver. In particular, FIG. 2 illustrates a semicircular-shaped waveform 40 transmitted from transmitter 22 of the first communication unit at time t₀ and FIG. 3 illustrates a triangular-shaped waveform 42 transmitted from transmitter 22A of the second communication unit at time t₁. The letter A has been appended to the reference numbers of the receiver and transmitter of the second communication unit to differentiate this transceiver from the transceiver in the first communication unit. It should be noted that the semicircle and triangle waveform shapes are arbitrary. These waveform shapes have been chosen to illustrate timing relationships of signals relative to one another, and therefore, the waveform shapes are not intended to portray particular signal types.

FIG. 4 illustrates signals being processed through receiver 12 of the first communication unit. Semicircular-shaped waveform 40 is processed at substantially time to, concurrent with transmitter 22 supplying semicircular-shaped waveform 40 for transmission from the antenna of the first communication unit (see FIG. 2). Receiver 12 also processes triangular-shaped waveform 42 received from the second communication unit at time (t₁ +T_{d}), where T_{d} is a time delay. Time delay T_{d} is equal to r/c, where “r” is the distance between the two communication units and “c” is the speed of light.

Thus, the distance between the first and second communication units is proportional to the time delay T_{d} between the two communication units.

FIG. 5 illustrates signals being processed through receiver 12A of the second communication unit. Receiver 12A of the second communication unit processes a semicircular-shaped waveform 40 received from the first communication unit at time t₀+T_{d} . Triangular-shaped waveform 42 is processed at substantially time t₁, this waveform being processed in receiver 12A concurrent with transmitter 22A providing triangular-shaped waveform 42 from the antenna in the second communication unit.

It will be appreciated that for clarity of illustration, the strength or amplitude of the signals illustrated in FIGS. 2-5 has not been drawn to scale. It should also be pointed out that either the first or second communication unit may initiate a transmission sequence and further that the signals being transmitted between the units may be the same or different. It should be noted that the first and second communication units may communicate synchronously or they may be unsynchronized, i.e., their clocks may differ by some fixed unknown time.

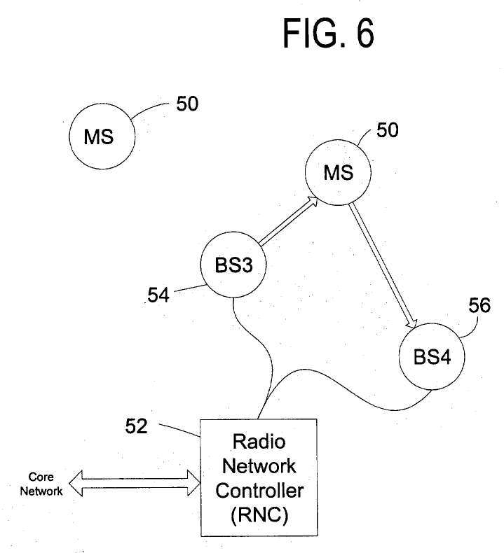

FIG. 6 illustrates a communication system in which the principles of the present invention may be practiced, and in particular, where mobile communication units 50 may generate ranging information that may be supplied to the network, and in at least one embodiment supplied through a Radio Network Controller (RNC) 52. The communication system may include a plurality of other communication units 54 and 56 that may be distributed within an area to provide wireless communication.

By way of example to illustrate operation, a range measurement procedure is initiated by the first communication unit transmitting semicircular-shaped waveform 40 at time to (see FIG. 2) and also processing semicircular-shaped waveform 40 in its own receiver 12 (see FIG. 4). The procedure continues with the second communication unit receiving semicircular-shaped waveform 40 at a time (t₀+T_{d} ) (see FIG. 5). At time t₁ the second communication unit transmits triangular-shaped waveform 42 (see FIG. 3) and further processes triangular-shaped waveform 42 in its own receiver 12A concurrent with transmitting the waveform (see FIG. 5). The first communication unit receives triangular-shaped waveform 42 for processing through receiver 12 at time (t₁+T_{d} ) (see FIG. 4). The procedure concludes with computations based on data stored in processors 30 and 30A (found in the respective first and second communication units), the data accurately reflecting the timing relationship between semicircular-shaped waveform 40 and triangular-shaped waveform 42 received in each of the two units.

It should be pointed out that when a communication unit processes its own signal that it transmits that the signal path delay within the communication unit is a predictable delay that may be removed via calibration techniques. Each communication unit may process the waveforms, the waveform received from itself and the waveform received from the other communication unit to determine the time-difference between the two waveforms. By way of example, the first communication unit calculates a time-difference that is ((t₁+T_{d} )−t₀) (see FIG. 4), while the second communication unit calculates a time-difference that is (t₁−(t₀+T_{d} )) (see FIG. 5).

To complete the range measurement procedure, one of the communication units may transmit its time-difference to the other communication unit or both communication units may transfer their calculated results to an independent location server. With one device now having both of the time-difference values, an average of ((t₁+T_{d} )−t₀) and (t₁−(t₀+T_{d} )) results in (t₁−t₀). For simplicity, the time to, i.e., the time that the first communication unit initiated transmitting semicircular-shaped waveform 40, may be set to zero and the value for t₁ (referred to as a timing offset) may be determined. Further, by computing half of the magnitude of the difference of these two time-difference values or [((t₁+T_{d} )−t₀)−(t₁−(t₀+T_{d} ))]/2, a value for the time delay T_{d} may also be determined. Thus, the distance between the two communication units and the timing offset may be determined.

If the signals or waveforms are captured digitally, then high resolution signal processing may be used to precisely determine the start of each of the four waveforms. For example, some WLAN implementations have samples at a 40 MHz clock frequency which implies a 25 ns sampling interval which corresponds to approximately a twenty-five foot resolution between samples. Thus, a simple algorithm that uses the timing of the sampling clock to the nearest sample may not be sufficient to estimate distances with fine precision, such as centimeter accuracy. However, signal processing algorithms may be used to store digital samples to accurately estimate the start of the waveform,

i.e., estimate the start of the waveform even between sampling points (the nearest 750th of a sample in the above example). For the signal processing in processors 30 and 30A the accuracy of the distance measurement will not only depend upon the signal-to-noise ratio but also on the duration of the waveform that is recorded. It should also be pointed out that waveform 40 may be separated in time from waveform 40A and rather than recording both waveforms and the noise in between, a counter may be used to count a number of samples in between the two waveforms.

The two communication units may be part of a network that takes diversity system concepts into account. Diversity systems are a collection of techniques that improve the Quality of Services (QoS) and the capacity of the system while maintaining a minimum quality. The performance of the system may be improved using the distance information derived in accordance with embodiments of the present invention. For instance, the distance information may be used in load sharing algorithms, soft-handoff algorithms, network management algorithms, in locating devices having specific applications and capabilities, among others. In general, the distance information may be used to improve communication between base stations and mobile users.

By now it should be apparent that range measurement data may be generated using two communication units, with both units generating time-difference values based on signaling between the two units. The time-difference values may be used in a network to improve communication.

While certain features of the invention have been illustrated and described herein, many modifications, substitutions, changes, and equivalents will now occur to those skilled in the art. For instance, the receiver portion of the transceiver shown in FIG. 1 may be replaced by a direct conversion technique that uses filtering without using mixers. It is, therefore, to be understood that the appended claims are intended to cover all such modifications and changes as fall within the true spirit of the invention.

What is claimed is:

1. A communication system comprising:
a first communication device; and
a second communication device having a receiver to receive a first signal transmitted by the first communication device and coupled to receive a second signal generated by the second communication device to transmit to the first communication device, where the first and second signals are used to generate a first time-difference value.

2. The communication system of claim 1, wherein a transmitter and the receiver of the second communication device are active to transmit the second signal and concurrently process the second signal through the receiver.

3. The communication system of claim 1, wherein the first communication device includes a receiver to receive the second signal transmitted by the second communication device and the first signal transmitted by the first communication device, where the first and second signals are used to generate a second time-difference value.

4. The communication system of claim 3, wherein a transmitter and the receiver of the first communication device are active to transmit the first signal and concurrently process the first signal through the receiver.

5. The communication system of claim 1, wherein the first and second time-difference values are used to generate a distance between the first and second communication devices.

6. The communication system of claim 1, further including:
a processor coupled to the receiver of the second communication device to receive a digital value of the first signal and a digital value of the second signal and a value from a counter that counts time intervals between the first signal and the second signal.

7. The communication system of claim 1, wherein the first communication device is a mobile and the second communication device is a base station in the communication system.

8. A communication system comprising:
a network of base stations; and
a mobile linked to at least one base station to transmit a first signal and use that first signal along with a second signal received from the at least one base station to generate a first time-difference value of the first and second signals.

9. The communication system of claim 8 wherein the at least one base station transmits the second signal and uses that second signal along with the first signal received from the mobile to generate a second time-difference value of the first and second signals.

10. The communication system of claim 9 wherein the first and second time-difference values are used to calculate a distance between the at least one base station and the mobile.

11. The communication system of claim 10 wherein the distance is used by the network to control handoff decisions within the communication system.

12. The communication system of claim 10 wherein the distance is determined by subtracting the second time-difference value from the first time-difference value and dividing that value in half.

13. A method comprising:
causing a first communication device to transmit a first signal to a second communication device and concurrently process the first signal in a receiver of the first communication device;
receiving a second signal in the receiver of the first communication device that is transmitted by the second communication device; and
calculating a first time difference in the first communication device between the first and second signals.

14. The method of claim 13, further including:
causing the second communication device to transmit the second signal to the first communication device and concurrently process the second signal in a receiver of the second communication device;
receiving the first signal in the receiver of the second communication device that is transmitted by the first communication device; and
calculating a second time difference between the first and second signals in the second communication device.

15. The method of claim 14, further including:
finding a difference value of the first time difference and the second time difference.

16. The method of claim 15, further including:
using the difference value to continuously track a distance between the first and second communication devices.

17. The method of claim 16, further including:
supplying the distance to a network as diversity information to change how the first communication device communicates with the second communication device.

18. A method comprising:
transmitting a first signal from a first communication device to a second communication device and concurrently processing the first signal in a receiver of the first communication device;
transmitting a second signal from the second communication device to the first communication device and concurrently processing the second signal in a receiver of the second communication device;
receiving the first signal in the receiver of the second communication device and the second signal in the receiver of the first communication device; and
calculating a first time difference value in the first communication device and a second time difference in the second communication device based on the first and second signals.

19. The method of claim 18, further comprising:
transmitting the first time difference value from the first communication device to the second communication device.

20. The method of claim 19, further comprising:
calculating a distance between the first and second communication devices using the first and second time difference values.
